(19) United States
(12) Patent Application Publication
(10) Pub. No.: US 2025/0151748 A1
(43) Pub. Date: May 15, 2025

(54) Confectionery Food Products Having Net Nutritional Value

(71) Applicant: Jonathan Elist, Beverly Hills, CA (US)

(72) Inventor: Jonathan Elist, Beverly Hills, CA (US)

(21) Appl. No.: 18/936,348

(22) Filed: Nov. 4, 2024

Related U.S. Application Data
(60) Provisional application No. 63/598,913, filed on Nov. 14, 2023.

(51) Int. Cl. A23G 3/44; A23G 3/38; A23G 3/40; A23G 3/42; A23G 3/48

(52) U.S. Cl. CPC A23G 3/44; A23G 3/38; A23G 3/40; A23G 3/42; A23G 3/48

(57) ABSTRACT

Disclosed is a net-nutritional confectionery topping including at least one starch, a protein, a fat, at least one functional build back ingredient, and at least one flavoring. The base of the protein is substantially formed of a plant based protein and a coconut fat which replaces the sucrose base of traditional confectionary toppings and is a healthier alternative to conventional toppings.

### CROSS REFERENCE TO RELATED APPLICATIONS

This application claims the benefit of priority to U.S. Provisional Patent Application No. 63/598,913 filed on Nov. 14, 2023, the disclosure of which is hereby incorporated by reference in its entirety.

### FIELD OF THE DISCLOSURE

The present disclosure relates generally to food products. More particularly, the present disclosure relates to confectionery food products, such as sprinkles, having net nutritional value.

### BACKGROUND OF THE DISCLOSURE

Confectionery food products are known for their delicious taste, but they are typically viewed as unhealthy due to their high sugar and carbohydrate content. These sweet treats are generally categorized into two main types: baker's confections, which include items such as pastries, cakes, and other baked goods, and sugar confections, such as candies, chocolates, and similar sweets. Common confections, in particular, are primarily composed of sugar, and a popular subset within this category is sprinkles, which includes a range of decorative toppings such as jimmies, nonpareils, beads, pearls, crystals, and various mixes. These small, colorful candies are commonly used as toppings or decorative elements to enhance the appearance and texture of desserts.

Sprinkles and other sugar confections come in a variety of colors and are often seen as an essential component in dessert decoration, adding a vibrant, appealing look to food products. However, due to growing health concerns, conventional methods have been developed to make these sweets less harmful by reducing their sugar content, using substitutes, or lowering their calorie counts. While these approaches aim to mitigate the negative health impacts associated with sugar-heavy confections, they often focus on reducing the perceived harm rather than making significant improvements to their nutritional profile. That is, the conventional approach has been to make these tasty food products less bad for you.

### BRIEF SUMMARY OF THE DISCLOSURE

The present disclosure relates to confectionery food products, such as sprinkles, having net nutritional value. The present disclosure focuses on sprinkles which are also known as jimmies, nonpareils, beads, pearls, crystals, and mixes thereof. The present disclosure uses the term “sprinkles” and those skilled in the art will recognize all such equivalents are contemplated, namely small balls, rods, or other shaped candy used as a topping for desserts, baked goods, ice cream, and other food products. Rather than making sprinkles less unhealthy from a nutritional perspective, the present disclosure contemplates formulations which provide a net nutritional benefit or value, while also being tasty and serving the purpose as a topping.

One aspect of the present disclosure generally relates to a net-nutritional confectionery topping including a protein present in up to about 100% and any of at least one starch present in the amount of 5% to 20%, a fat present in the amount of 10% to 25%, at least one functional build back (FBB) ingredient present in the amount of 5% to 30%, and at least one flavoring present in the amount of 0.1% to 5%.

A further aspect of the present disclosure generally relates to a method for producing a net-nutritional confectionery topping, including mixing water and a non-sucrose sweetener and forming a wet portion, sifting one or more of a protein, a starch, a sweetener, a functional build back (FBB), and a flavoring, forming a dry portion, combining the wet portion and the dry portion with a melted fat, extruding the combination onto a surface, and drying the mixture at up to 225 F for up to 15 mins.

### BRIEF DESCRIPTION OF THE DRAWINGS

The present disclosure is detailed through various drawings, where like components or steps are indicated by identical reference numbers for clarity and consistency.

FIG. 1 is a diagram of a method for preparing a confectionary topping.

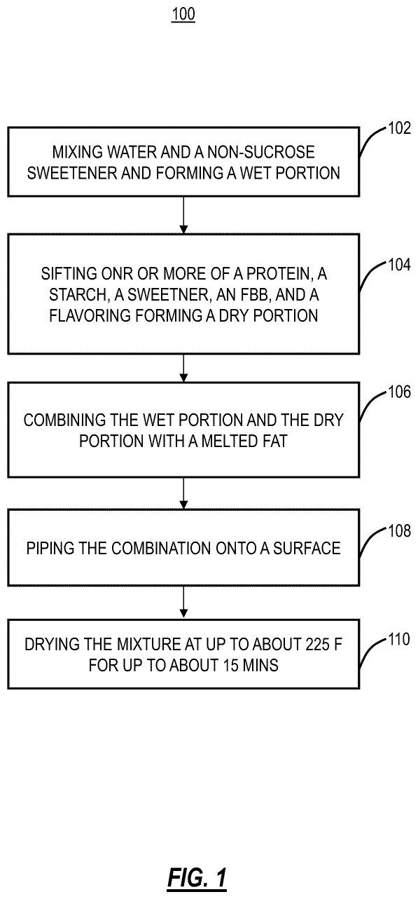

### DETAILED DESCRIPTION OF THE DISCLOSURE

Again, the present disclosure relates to confectionery food products, such as sprinkles, having net nutritional value. The base concept is to provide healthful confection options, particularly sprinkles, which includes jimmies, nonpareils, beads, pearls, crystals, and mixes thereof. The base of the confection options are a consumable substance, which may include one or more of the following: seeds (e.g., chia, flax, hemp), vitamins (e.g., Vitamin C, calcium, iron), medications, nuts (e.g., walnuts, pistachios), protein (e.g., whey, tofu), dairy (e.g., yoghurt, cheese), dairy alternatives (e.g., almond milk, soy milk), minerals (e.g., salt), fiber (e.g., oatmeal, root vegetables), legumes (e.g., lentils, beans, peas), fungi (e.g., Lion's Mane), grains (e.g., wheat, brown rice), meat (e.g., dried liver, salmon), fruits (e.g., dried strawberries, bananas), vegetables (e.g., dried broccoli, spinach), alkaline, acid (e.g., fatty acids), or water.

The confection options will either be consumed on their own or in combination with baked goods and other foods or beverages. The base elements of the confectionary items utilize healthful versions of sweeteners (e.g., erythritol, stevia, maple syrup, honey), healthful versions of oil (e.g., palm oil, coconut oil, cocoa butter), and healthful versions of food coloring (e.g., dyes derived from fruits and vegetables).

### Net-Nutritional Confectionary

Traditionally, confectioneries, desserts, and other sweet treats often include toppings that are predominantly sugar or sucrose. One of the leading causes of sickness and disease is obesity and obesity related illnesses, caused largely by the overconsumption of sugar. Moreover, many desserts and treats contain artificial ingredients that could potentially pose health hazards. Disclosed herein are compositions and methods for confectionery toppings which reduce the caloric density thereof and, in some aspects, provide a net nutritional benefit. A net-nutritional benefit is generally compared against a traditional composition. For example, a topping of the present disclosure, such as a sprinkle can be compared to a sugar-based sprinkle. If the sprinkle of the instant disclosure has fewer calories, less sugar, higher nutrient density, or the like, it can be considered net-nutritional topping.

As used herein, a confectionary generally refers to a consumable item. More particularly, a confectionary generally refers to but is not limited to sweets, candies, baked goods, treats, pastries, cakes, cupcakes, cookies, ice cream, donuts, brownies, waffles, chocolates, or the like. As used herein, the term topping generally refers to a substance which can be added to a food product. More particularly, a topping can be a substance added to a confectionary such as sprinkles, hundreds and thousands, jimmies, nonpareils, beads, pearls, candy pieces and the like.

The term “sprinkles” as used herein is intended to be non-limiting and generally refers to an object of the present disclosure beyond ordinary sprinkles. Accordingly, the present disclosure can provide novel confectionaries and toppings. Moreover, the compositions of the present disclosure can be consumed both independently and in combination with other food items. For example, the composition of the present disclosure can be used as a topping on a food item (i.e., a cupcake), as a garnishment on a dish, or eaten by themselves. As used herein, the term “base” generally refers to a majority portion of the composition.

In one aspect, the topping can be substantially composed of a protein. The protein can be formed from any source of protein, such as and without limitation a plant protein, whey protein, casein protein, or meat protein. The protein base is the constituent which replaces the sucrose base found in traditional toppings. In other words, the present disclosure includes a topping defining a body or majority component of protein instead of sucrose or other filler material. Generally, it is envisioned that any substance which has a net-nutrient value over sucrose can be used. Protein as a base provides measurable benefits over a sucrose base. In a first aspect, the protein content of the topping adds a source of protein to foods which typically wouldn't not contain any protein, such as desserts and breakfast items. Advantageously this is useful for individuals looking to increase their protein intake. Further, the amino acids which are found in the base plant protein of the toppings described herein are beneficial for muscle repair, muscle protein synthesis, metabolic, and overall health. Sucrose-based toppings are almost entirely made of sugar, which can quickly spike blood glucose levels. The rapid energy boost and crash can be avoided by reducing sugar intake via the toppings described herein. The protein based toppings tend to have much lower caloric density which is critical for those who are conscious about their caloric intake.

In typical aspects, the base of the topping can be a consumable protein substance. The base can include seeds, vitamins, medications, nuts, dairy or dairy alternatives, minerals, fiber, legumes, fungi, whole grains, meat, fruits, vegetables, alkaline, acids (e.g., fatty acids, or water. The base can be seeds, such as and without limitation chia, hemp, or pumpkin seeds which can be dehydrated, crushed, and/or lightly sweetened or flavored to add a “crunchy” texture. The seeds can add protein, healthy fats, and/or fiber to the base and can enhance the nutrition and taste of the sprinkle. It is envisioned that the toppings can be vitamin infused or doped with vitamins and minerals. For example, the base of the toppings can include vitamin D, B12, or vitamin C. The vitamins can be encapsulated in a coating on the topping or can be included in the base. The inclusion of vitamins can be beneficial for individuals looking to supplement their diet with specific vitamins or a general panel of vitamins without the inclusion of a separate pill.

The toppings can include medications. The toppings can be prescription medications or over the counter medications. The medications can be controlled-release medications or dietary supplements like probiotics. The medications can be incorporated as micro-encapsulated particles or combined with the base of the topping. The base can include supplements such as iron and calcium. The addition of supplements and medicine in this form can increase the palatability of certain drugs. In example only, for children, who are often notoriously difficult to administer medicine to, the toppings could be used as a more palatable and tastier alternative to conventional medicine. The topping can include a stimulant, such as caffeine. Caffeine is consumed for its stimulating effects to provide energy, focus, and mood improvement. The stimulant can be, for example, caffeine, nicotine, theobromine, guarana, yerba mate, green tea extract, maca root powder, matcha powder, or the like. Example embodiments of the topping of the disclosure can include a caffeinated sprinkle.

The base of the topping can be formed of nuts. The nuts can be finely ground and combined with the base. The nuts can be, without limitation, almonds, cashews, and/or walnuts which form the base of the sprinkle to provide a nutty flavor, and protein. In addition, the nuts can offer healthy fats and can be beneficial for heart health while adding a satisfying crunch. The topping can include dairy or dairy alternatives, such as whey protein, casein protein, milk powder, or almond or soy milk. Such dairy and dairy alternatives can be provided to the base of the topping in a powdered form and can offer a more complete protein profile while non-dairy alternatives are available to those with dietary restrictions. The base can include trace minerals, such as and without limitation magnesium, zinc, and calcium. The health benefits of these included minerals are particularly noted for those who are mineral deficient. Additionally, these minerals can be bound to the protein of the base of the topping for controlled absorption. For example and without limitation, the minerals can be bound with a protein coating or plant based protein base of the base of the topping for controlled absorption.

The base of the topping can include a fiber source. Such fiber sources can include, but are not limited to psyllium husk, oats, or chicory root. As such, the fiber source can serve as the base ingredient of the confectionary and can promote digestive health. The fiber can be formulated to help with satiety and to support gut health. Continuing, the base can include legumes, such as chickpeas, lentils, or black beans which can be roasted, ground, and used as the base. Legumes can incorporate protein, fiber, and essential nutrients while adding a slight crunch or texture to the sprinkle. In some aspects, the sprinkle can include fungi. More specifically, the fungi can include mushroom powers such as lion's mane, shiitake, or various other mushroom to add unique flavors and health benefits. Fungi are high in protein, contain essential amino acids, and can provide additional immune-boosting properties.

The base of the sprinkle can include whole grains, such as and without limitation quinoa, amaranth, or millet. These whole grains can be puffed or toasted and used as a base for the sprinkles. Importantly, whole grains add complex carbohydrates and protein, offering sustained energy release with added crunch. The base can include meats, such as dehydrated beef, chicken, or fish, or protein powders formed of meat. By adding meat to the base, the sprinkle can incorporate savory flavors with high protein content. As such, sprinkles which include meat can be used as toppings for savory dishes like salads, soups, or the like for a protein boost. The base of the topping can include fruits. The fruits can be freeze dried and can be a naturally sweet component of the topping. For example, the sprinkle can include freeze-dried berries such as strawberries, blueberries, or apples which bring a fruity flavor and natural sweetness along with vitamins and antioxidants.

Some aspects of the topping can include a base formed of vegetables. For example, the base can include dehydrated and ground vegetables. Examples of such include without limitation carrots, spinach, or beets. Certain vegetables like beets can be used to add color. Other vegetables can be added to add subtle flavors and add a boost of vitamins and nutrients. As such, vegetable-based sprinkles as disclosed herein can offer nutritional diversity, particularly for children or adults who are seeking a higher or hidden vegetable intake. The base can include alkaline rich ingredients such as spirulina, chlorella, or spinach power which can help to balance body pH while providing plant-based protein, vitamins, and minerals. Also, the base can include acids, such as fatty acids including omega-3 rich chia seeds or ground flaxseeds. These added fatty acids can be incorporated to promote heart health and provide a boost where a healthy fat boost is beneficial. The base can be hydrated and can define a water-rich base, for example formed from aloe vera or cucumber extract. These moisture carrying bases can provide hydration along with a light crunch.

The toppings can be consumed directly as a standalone snack for a quick and sweet treat without additional foods. The toppings can be applied on a portion of food or dessert items such as cakes, cookies, brownies, muffins, and cupcakes which can enhance both the appearance and flavor. The toppings can be sprinkled over frozen desserts, such as ice cream, frozen yogurt, or milkshakes for added texture and sweetness. In some aspects, the toppings can be incorporated onto breakfast foods, where the toppings are mixed into or sprinkled over the top of for example pancakes, waffles and French toast which adds color and flavor to traditional breakfast items. The toppings can be incorporated onto hot and cold beverages; the toppings can be a garnish on coffee, hot chocolate, or lattes either on a whipped cream portion or directly in the drink or incorporated into milkshakes, smoothies, or teas. As such, the toppings can give an extra touch, a garnished appearance, or create a pleasing visual and tasty confectionary. The toppings can be used in yogurts or oatmeal where they can be mixed in or used as a topping.

In some aspects, the base of the topping can include a healthful sweetener. The topping can use an alternative to sugar, wherein an element of the topping is a healthier than sugar alternative. Traditional sweeteners, such as refined sugar, are high in calories, promote tooth decay, and cause spikes in blood sugar which can result in energy crashes and hunger. Further, many healthy sweeteners are easier to digest which can avoid bloating and discomfort associated with excess sugar intake. The topping can include any alternative to sucrose as a sweetener. The base can include Erythritol, which is a natural sugar alcohol that is low in calories. Erythritol does not spike blood sugar which can make the topping suitable for diabetics and those on low carb diets. The healthful sweetener can be stevia, which is a zero-calorie sweetener derived from the Stevia plant. Similar to Erythritol, Stevia can provide the topping with a naturally sweet taste without the glycemic impact of sucrose. The sweetener of the base can be a syrup, for example maple syrup, which is a minimally processed natural sweetener rich in antioxidants and trace minerals. As such, maple syrup can add complex sweetness and flavors. The base sweetener can include honey, which can incorporate antimicrobial properties and antioxidants. As such, honey can be a natural flavor and sweetener.

The base of the topping can include a healthy oil. The topping can include an alternative to traditional oils, wherein an element of the topping is a traditional oil replacement. Traditional oils like hydrogenated vegetable oils often contain trans fats, which are linked to inflammation and cardiovascular diseases. The topping can include healthy oils which are often rich in antioxidants that protect cells from damage and reduce oxidative stress. The topping can include any alternative to traditional oil. The topping can include coconut oil, which is high in medium-chain triglycerides (MCTs) that can boost energy and metabolism. Coconut oil can also impart a pleasant flavor and can increase stability at higher temperatures. The topping can include palm oil, which can incorporate vitamin A and E while providing structure to the topping. The topping can include cocoa butter, which is a natural fat source from cocoa beans. Cocoa butter can contribute to a creamy chocolate-like flavor and increased antioxidants.

The topping can use food coloring to create enhanced visual appearance. For example, the food coloring can be used to create a rainbow color scheme. The topping can include a healthful food coloring having advantages over artificial dyes. Artificial food coloring (for example, Red 40, Yellow 5, and Blue 1) have been linked to health concerns, including allergies, hyperactivity, and potential carcinogenic effects. The topping disclosed herein can incorporate natural food colorings in place of artificial food colorings. The natural food colorings can be derived from fruits, vegetables, and plants and are substantially free from synthetic chemicals, making them safer for sensitive populations. In example, the topping can incorporate fruit and vegetable based dyes, or any substance where colors are extracted from natural sources such as beets (red), turmeric (yellow), and spirulina (blue). The natural food colorings can include spices such as saffron and paprika to add colors and optionally flavors. The natural food colorings can include herbs and flowers such as extracts from hibiscus, matcha, and butterfly peas to add unique colors (for example, pink, green, and purples).

Notably, a major portion of the topping can be protein based. The base of the sprinkle can be substantially formed of protein. As such, the protein-based sprinkle disclosed herein can offer a boost in nutritional value by replacing the sucrose commonly used in traditional sprinkles. Protein takes longer to digest, helping people feel fuller for longer periods. This could be particularly beneficial for those looking to manage weight or reduce sugar cravings. Adding protein to foods typically low in protein, like desserts or snacks, can help balance meals and improve nutrient intake throughout the day. Protein sprinkles could make traditionally indulgent treats healthier without changing their flavor or appeal. Protein is essential for muscle repair and growth, especially post-exercise. A protein sprinkle can offer a convenient way to add muscle-supporting protein to any meal, snack, or even beverages like smoothies and coffee. Protein sprinkles could cater to different dietary preferences (e.g., vegan, keto, paleo) depending on the type of protein used, making it versatile and accessible for a wide range of consumers.

### Exemplary Formulation

The present disclosure provides a net-nutritional confectionary topping. More specifically, the topping as described here can include one or more ingredients provided in this specification to achieve a health benefit over traditional confectionery toppings, such as sprinkles. For example, a sprinkle manufactured with any of the ingredients or methods disclosed herein can be a healthier option to sprinkles prepared from sucrose or with traditional ingredients. The following is a summary of exemplary ingredients for certain recipes:

### Rainbow Sprinkle Ingredients

Ingredients: Sugar, Palm Kernel & Palm Oil, Corn Starch, Sunflower Lecithin, Maltodextrin, Carnauba Wax, Cellulose Gum.

### Chocolate Sprinkle Ingredients

Ingredients: Sugar, Palm Kernel and Palm Oil, Cocoa Powder (processed with alkali), Corn Starch, Sunflower Lecithin, Natural Flavor, Maltodextrin, Carnauba Wax, Cellulose Gum.

### Example Best for You (BFY) Ingredients

The healthful topping can include any of the following: Sweeteners & Bulking Agents: Coconut Sugar, Date Sugar, Maple Sugar, Allulose, Chicory Root Fiber. Fats: Sustainable Palm, Cocoa Butter, Deodorized Coconut Oil. Starches & Gums: Flax Seed Powder, Tapioca Starch, Arrowroot Powder, Acacia Gum, Citrus Fiber. Wax: Beeswax.

More generally, the sprinkles can include any of: Starches: Melojel, Tapioca Starch, Protein: Faba Bean Protein, Fats: Cocoa Butter, Coconut Oil, Functional Build Back (FBB) Ingredients: Allulose, Erythritol, Coconut Sugar, Cocoa Powder, Flavors: Birthday Cake Flavor (Fona 821.0518U), Vanilla Flavor (Gold Coast 654814), Vanilla Flavor (Primetime Everfresh Vanilla), Chocolate Flavor (Edlong 1412166), and Fruit and Vegetable Juice Concentrates: Carrot JC, Purple Carrot JC, Red Beet JC, Jicama JC (+blue/green spirulina). Alternative embodiments can include, but are not limited to: arrowroot starch, potato starch, cornstarch, pea protein isolate, brown rice protein, hemp protein, avocado oil, almond oil, shea butter, stevia, monk fruit sweetener, xylitol, yacon syrup, natural flavor extracts such as almond, coconut, or hazelnut, cacao powder, cinnamon or nutmeg, spinach juice concentrate, beet juice powder, pomegranate juice, or the like.

The following table provides an exemplary composition for a net-nutritional chocolate sprinkle:

Chocolate Sprinkles

| Label Declaration | % (wt %) |
|---|---|
| Faba Bean Protein | .1%-50% |
| Coconut Sugar/Erythritol | 9.7%-10.44% |
| Tapioca Starch | 9.24%-10.35% |
| Stevia Leaf Sweetener/Steviol Glycosides | .04%-.0625% |
| Coconut Oil | 18.82%-20.1% |
| Natural Flavor | .75%-.81% |
| Cocoa Powder | 13.8%-14.7% |
| Water | .1%-50% |

In addition, the following table provides an exemplary composition for a net-nutritional rainbow sprinkle.

Rainbow Sprinkles

| Label Declaration | % (wt %) |
|---|---|
| Faba Bean Protein | .1%-50% |
| Coconut Sugar | 25.3%-26.9% |
| Tapioca Starch | 10.78%-11.95% |
| Stevia Leaf Sweetener/Steviol Glycosides | .04%-.13% |
| Coconut Oil | 18.82%-20.1% |
| Natural Flavor (vanilla) | .81%-.85% |
| Fruit Juice Concentrate | 8.8%-13.7% |
| Water | .1%-50% |

The rainbow sprinkles can be configured with a plurality of colors, so that a collection of rainbow sprinkles can be an assortment of colors. That is, a collection of rainbow sprinkles can be a variety of solid colored sprinkles. In example only, the rainbow colors can be formed with natural Juice Colorings (JC) such as: Red: Red Beet JC, Orange: Carrot JC+ Red Beet JC (4:1), Yellow: Carrot JC, Purple: Purple Carrot JC, Blue: Jicama JC+1% Blue Spirulina, Green: Jicama JC+1% Green Spirulina. The sprinkles can include at least one flavoring. Example flavorings can include without limitation Birthday Cake Flavor (Fona 821.0518U), Vanilla Flavor (Gold Coast 654814), Vanilla Flavor (Primetime Everfresh Vanilla), and Chocolate Flavor (Edlong 1412166). The starch can be Melojel, or tapioca starch. The protein can be a faba bean, pea, or chickpea protein. The FBB ingredients can be Allulose, Erythritol, Coconut Sugar, Cocoa Powder. The fat can be cocoa butter or coconut oil.

The starch can be used to adjust the texture of the treat. For example, the amount of starch present can determine how “crunchy” or “crisp” the toppings are. The starch can absorb water during the manufacturing process of the topping. The starch can also undergo gelatinization when exposed to heat, where the granules swell and thicken the mixture. Proper gelatinization of the starch can form a network which can contribute to the “crispiness” of the topping. In some embodiments, the starch can be present in the topping at the percentages disclosed herein with about a +/−5% variance. In other embodiments, the starch can be present in the topping at the percentages disclosed herein with about a +/−2% variance.

The fruit juice concentrate can provide sweetness and coloring to the topping. The fruit juice concentrate can contain natural sugars such as fructose and glucose which, when combined with the topping can increase the sweetness of the topping. Moreover, the fruit juice concentrate can provide a more complex flavor profile when compared to sucrose. The fruit juice concentrate can impart fruity flavors to the topping which enhances the overall taste of the sprinkle. Moreover, the fruit juice concentrates can impart pigments, for example anthocyanins, carotenoids, and betalains for color to the topping. In some aspects, the fruit juice concentrate can participate in Maillard reactions or caramelization of the topping and can add moisture which affects the texture. In some embodiments, the fruit juice concentrate can be present in the topping at the percentages disclosed herein with about a +/−5% variance. In other embodiments, the fruit juice concentrate can be present in the topping at the percentages disclosed herein with about a +/−2% variance.

The fat can help modulate a soft/crisp balance and help develop a “good mouth feel.” It is envisioned that the topping will define a consistency which is moderately soft but retain some “crunch.” The fat content can coat the particles of the topping and inhibit gluten formation, preventing a dense and chewy texture. The fat can retain moisture to the sprinkle during cooking, preventing the sprinkle from drying out. The fat can melt at higher temperatures. Fats with higher melting points (e.g., coconut oil, shortening) don't fully melt until the sprinkle is already set, which helps create a crisp structure on the exterior. This property can form a crunchy texture that is desirable. In some embodiments, the fat can be present in the topping at the percentages disclosed herein with about a +/−2% variance. In other embodiments, the fat can be present in the topping at the percentages disclosed herein with about a +/−1% variance.

The main ingredient of the sprinkle can be protein. In some aspects, the entire topping can comprise a protein, such as a plant protein, wherein the base is substantially 100% protein. In other aspects, the topping, such as the base of the topping, can be about 51% to 100%. In some aspects, the protein can be about 0.1% to 50% of the total volume or weight of the sprinkle. In other aspects, the protein can be about 10% to 35% of the total volume or weight of the sprinkle. More generally, the base of the topping can comprise any amount by weight or volume of protein, from 0.1% to 100%. The protein can be emulsified or dissolved in water during cooking to form and combine it with other ingredients. The protein can be a vegetable protein which forms the base of the sprinkle. Example proteins that have been found suitable include pea proteins, legume protein, and chickpea protein, although other protein bases are contemplated. The protein can affect the sweetness. It is envisioned that the sprinkle will have a target sweetness similar to the sweetness of sucrose-based sweeteners.

### Process of Making

The process of making the sprinkles specifically will involve extrusion, which is a method of shaping and forming the sprinkle strands. More specifically, this involves:

Ingredients Preparation: The primary ingredients for making sprinkles include sweetener, vegetable fat or oil, and food coloring. The sweetener and consumable substance (as described above, e.g., seed mix, vitamins, vegetables) provide the base, the fat or oil helps with the extrusion process and texture, and food coloring gives the sprinkles their vibrant colors. In one example, to prepare the net healthy sprinkle with natural coloring, combine a non-sucrose sweetener as the primary sweetener with a small amount of vegetable oil, such as coconut oil, to help bind the mixture and soften the texture. Add natural powdered food colorings—like beet powder for a red hue or turmeric for a yellow tint—to create vibrant colors. This mixture can then be extruded or shaped into small, sprinkle-sized pieces and allowed to set by either air-drying or baking at a low temperature until firm. In an alternative example, for a nutrient-enriched option, a vitamin-infused sprinkle could be made by mixing finely powdered non-sucrose sweetener or a low-glycemic sweetener such as erythritol with powdered vitamins, like vitamin C or B-complex, to add a health boost. This blend can be bound with a neutral oil, such as sunflower oil, which assists in smooth extrusion and texture. Food coloring can be added to create a variety of shades, and the mixture is then extruded or shaped before being dried or cooled until solid. In a yet further example, a textured sprinkle with added nutrition can be created using a mix of finely ground seeds and powdered vegetables, blended with a low-glycemic sweetener for taste. Binding with a mild vegetable oil aids the extrusion process, ensuring the sprinkle holds its shape. Natural food coloring can be added for visual appeal before shaping and drying the pieces.

Mixing: The sweetener and consumable substance base, vegetable fat or oil, and food coloring are thoroughly mixed together in a large mixer. This creates a pliable and colored dough. In an example, to create the topping dough, begin by combining the sweetener, the chosen consumable substance base (such as a seed powder or vitamin blend), a vegetable fat or oil, and food coloring in a large mixer. As the mixer thoroughly blends these ingredients, a pliable, evenly colored dough forms. For example, to make a vibrant red vitamin-infused sprinkle dough, powdered non-sucrose sweetener can be mixed with a vitamin supplement powder, coconut oil, and natural red beet powder for coloring. The resulting dough will have a smooth consistency, allowing it to be easily shaped into sprinkles. In another exemplary embodiment, a sprinkle dough can be made by mixing a low-glycemic sweetener like erythritol with finely ground chia seeds for added texture, vegetable oil for pliability, and turmeric powder for a warm yellow hue. This mixture blends into a soft, pliable dough with a golden color and a mildly nutty flavor from the chia seeds, creating a sprinkle base rich in texture. In yet another exemplary embodiment, to create a colorful vegetable-based sprinkle dough, powdered non-sucrose sweetener can be mixed with finely ground dehydrated vegetables, such as spinach or carrot powder, combined with sunflower oil, and an appropriate amount of green or orange food coloring. This can produce a malleable dough that retains a vibrant color while also incorporating vegetable nutrients, ideal for health-oriented sprinkles.

Extrusion: The dough is then fed into an extrusion machine. The dough is pushed through a die at the end of the barrel. The die has small holes or slits that shape the extruded material into thin strands. The die can have various shapes and sizes to produce different sprinkle shapes (e.g., round or elongated). In example, once the dough has been thoroughly mixed, it can be fed into an extrusion machine, where it is pushed through a die located at the end of the machine's barrel. The die features small holes or slits that determine the shape of the sprinkles as the dough is extruded. For instance, using a die with small, round holes creates thin, cylindrical sprinkles similar to traditional “jimmies” or rod-shaped sprinkles. In another exemplary embodiment, if an elongated sprinkle shape is desired, a die with narrow, rectangular slits can be used, producing flatter, elongated sprinkles that add a unique texture to desserts. For specialty sprinkles, the die might contain a pattern of star or heart-shaped openings, resulting in tiny, decorative sprinkles ideal for themed baking. In yet another exemplary embodiment, to make larger, round confetti-style sprinkles, the dough could be pushed through a die with circular holes of a wider diameter. This creates chunky, circular sprinkles that can add a bold, colorful topping to cakes and pastries. By selecting different die shapes and sizes, the extrusion process can be customized to produce various sprinkle shapes to suit diverse applications.

Cooling: As the dough is extruded, it comes into contact with cool air or a cooling chamber. This rapid cooling process helps harden the sprinkle strands and maintain their shape. In an example, as the dough exits the die in thin strands, it is immediately exposed to cool air or enters a cooling chamber, which rapidly solidifies the strands. This quick cooling process ensures that the sprinkles harden almost instantly, preserving their shape and preventing deformation. For instance, cylindrical sprinkle strands extruded from round holes are cooled in a chamber with controlled airflow, allowing them to solidify evenly and maintain their smooth, rod-like appearance. In an alternative example, if flatter, elongated sprinkles are being made, the cooling chamber's airflow can be adjusted to provide gentle cooling to prevent breakage while still firming the strands quickly. The cooling system may even incorporate a conveyor that transports the strands through a cool environment at a slow, consistent speed, allowing them to harden without distortion. In yet another example, for larger, confetti-style sprinkles, the dough strands can be cooled by directing a light stream of cool air directly over each strand as it emerges. This targeted cooling keeps the wider sprinkle shapes intact and hardens them evenly, preparing them for the next processing step. The use of various cooling techniques ensures that each sprinkle shape retains its form and texture, regardless of size or shape.

Cutting: Once the extruded substance strands have cooled and hardened, they are cut into smaller, uniform lengths. The length of the cuts determines the size of the sprinkles. In example, after the extruded strands have cooled and hardened, they are fed into a cutting mechanism that chops them into smaller, uniform lengths. This cutting process is crucial, as the length of the cuts directly determines the final size of the sprinkles. For example, a cutter set to create shorter lengths will produce tiny sprinkles suitable for detailed decorating, while longer cuts can result in larger, more prominent sprinkles ideal for topping cupcakes or desserts. In an alternative example, a precision cutting system is employed, allowing for adjustable settings to create various sprinkle sizes. This flexibility enables the production of a range of sprinkle types, from fine decorations to chunky toppings. For instance, the cutting mechanism can be programmed to alternate between sizes, producing a batch of sprinkles that includes both small and medium lengths for visual variety. In yet another example, a rotary cutter can be utilized, where hardened strands pass through rotating blades that slice them into consistent lengths as they exit the cooling chamber. This method ensures uniformity and can be fine-tuned to produce sprinkles that meet specific market demands, such as a gourmet line featuring larger, artisanal sprinkles. The ability to control the cutting length enhances the versatility of the production process, allowing manufacturers to cater to diverse customer preferences.

Drying: The cut sprinkles are left to dry further, which removes any remaining moisture and ensures they become crisp and stable. In an example, once the sprinkles have been cut into uniform lengths, they are spread out on drying trays and left to dry further. This additional drying phase is essential, as it removes any remaining moisture, ensuring the sprinkles become crisp and stable. For example, the trays can be placed in a temperature-controlled drying room where warm, circulated air helps accelerate the evaporation of moisture, resulting in a crunchier texture. In another example, a conveyor belt system can be used, where the cut sprinkles are continuously moved through a drying chamber equipped with dehumidifiers. This setup allows for consistent airflow and humidity control, further enhancing the crispiness of the sprinkles. The duration of the drying process can be adjusted based on the desired final texture, enabling manufacturers to achieve a perfect crunch that meets consumer expectations. Additionally, for specialty sprinkles infused with flavors or natural colorings, a gentle drying process at lower temperatures may be employed to preserve the integrity of the flavors while still ensuring the sprinkles remain stable. This method also allows for the creation of artisan sprinkles that have a more delicate texture and enhanced flavor profile. Ultimately, the drying phase is crucial for achieving a final product that is not only visually appealing but also has the desired crunch and stability for use in various baked goods and confections.

Packaging: After drying, the sprinkles can be typically sorted by color and shape. They are then packaged into containers or bags for distribution to consumers or businesses. In one example, after the drying process is complete, the sprinkles can undergo a sorting phase where they are categorized by color and shape. This sorting is typically accomplished using automated systems equipped with color sensors and sorting mechanisms that efficiently separate the sprinkles based on their visual characteristics. For instance, a conveyor belt system can transport the sprinkles past sensors that detect color variations, allowing for the precise grouping of similar shades, such as separating vibrant reds from pastel hues or differentiating star-shaped sprinkles from traditional round ones. In another example, a manual inspection may be performed to ensure quality control, where workers visually check the sorted sprinkles for consistency and defects. This dual approach of automated and manual sorting ensures that only the highest-quality sprinkles make it to packaging. In yet another example, once sorted, the sprinkles are packaged into containers or bags, ready for distribution to consumers or businesses. Various packaging options can be utilized, such as resealable bags for home use or bulk containers for bakeries and food manufacturers. The packaging is often designed to highlight the vibrant colors and shapes of the sprinkles, making them visually appealing on store shelves. Additionally, labeling can provide essential information about the ingredients and potential allergen warnings, catering to consumer needs. Ultimately, this final step ensures that the sprinkles are not only organized and appealing but also ready for the market, meeting the demands of both retail and wholesale customers.

The extrusion process is what gives sprinkles their unique shape and texture.

Different die designs on the extrusion machine can create various sprinkle shapes, such as long jimmies or nonpareils (tiny spheres). The addition of food coloring during mixing allows for a wide range of colorful sprinkles to be produced. It is important to note that the ingredients and exact manufacturing process may vary from one manufacturer to another, but the general extrusion process remains a common method according to the present disclosure for producing sprinkles. Notably, the preparation of the net healthy sprinkles described herein requires increased hydration when compared to conventional sprinkle manufacture. More specifically, the preparation and/or method of manufacture of the toppings of the present disclosure requires increased water content compared to sucrose based sprinkles.

An example of manufacture can include 1. Mix the water and the stevia together, set aside. When making the rainbow sprinkles, add the juice concentrate as well. 2. Sift together all the dry ingredients and add to a mixing bowl. 3. Add the ingredients from step 1 to the bowl along with the melted coconut oil. 4. Pipe the sprinkles onto a baking sheet lined with parchment paper. 5. Dry the sprinkles at 225 F for 15 mins or until the sprinkles break apart.

Disclosed herein is a method 100 for forming a net-nutritional confectionary topping. The method 100 can include mixing water and a non-sucrose sweetener and forming a wet portion. The method 100 can include sifting 104 one or more of a protein, a starch, a sweetener, an FBB, and a flavoring forming a dry portion. The method 100 can include combining 106 of the wet portion and the dry portion with a melted fat. The method 100 can include extruding 108 or piping the combination onto a surface. The method 100 can include drying 110 the mixture at up to about 225 F for up to about 15 mins.

### EMBODIMENTS

The composition can include a net-nutritional confectionery topping including at least one starch present in the amount of 5% to 20%; a protein present in the amount of up to 100%, a fat present in the amount of 10% to 25%; at least one functional build back (FBB) ingredient present in the amount of 5% to 30%; and at least one flavoring present in the amount of 0.1% to 5%. The composition can include wherein the at least one starch is present in the amount of 9.8% to 11.4%, the protein is present in the amount of 13.5% to 15.75%, the fat is present in the amount of 18.25% to 19.75%, the FBB is present in the amount of 24% to 26%, and the flavoring is present in the amount of 0.78% to 0.84%. The net-nutritional confectionery topping can include further comprising at least one fruit and vegetable juice concentrate present in the amount of 9.5% to 10.5%. The net-nutritional confectionery topping can include wherein the fruit and vegetable juice concentrate (JC) is one or more of: a carrot JC, a purple carrot JC, a red beet JC, a Jicama JC, and blue/green spirulina.

The net-nutritional confectionery topping can include wherein the protein is a vegetable based protein that defines the dominant ingredient of the topping. The net-nutritional confectionery topping can include wherein the protein is one of a pea protein, a legume protein, a chickpea protein, a hemp protein, a soy protein, a seed protein, a rice protein, a nut protein, a lentil protein, or a faba bean protein. The net-nutritional confectionery topping can include further comprising one or more of a vitamin, a medication, or a stimulant. The net-nutritional confectionery topping can include wherein the FBB ingredient is one of Allulose, Erythritol, coconut sugar, and coconut powder. The net-nutritional confectionery topping can include wherein the fat is one or more of cocoa butter and coconut oil. The net-nutritional confectionery topping can include further comprising a stevia leaf sweetener or steviol glycosides. The net-nutritional confectionery topping can include further comprising water present in the amount of 18% to 32%. The net-nutritional confectionery topping can include wherein the topping does not include sucrose. The net-nutritional confectionery topping can include wherein the flavoring is one of: vanilla, chocolate, and birthday cake flavor.

The net-nutritional confectionery topping can include wherein the topping is a chocolate sprinkle comprising a faba bean protein present in the amount of about 14.24%, a coconut sugar/Erythritol blend present in the amount of about 10.04%, a tapioca starch present in the amount of about 9.84%, a stevia leaf sweetener/steviol glycoside blend present in the amount of about 0.05%, a coconut oil present in the amount of about 19%, a chocolate flavoring present in the amount of about 0.79%, a cocoa powder present in the amount of about 14.25%, and water present in the amount of about 31.28%. The net-nutritional confectionery topping can include wherein the topping is a rainbow sprinkle comprising: a faba bean protein present in the amount of about 15%, a coconut sugar present in the amount of about 26.12%, a stevia leaf sweetener/steviol glycoside blend present in the amount of about 0.05%, a coconut oil present in the amount of 18.55%, a vanilla flavor present in the amount of about 0.83%, a fruit juice concentrate present in the amount of about 10%, and water present in the amount of about 18.08%.

Disclosed herein is a method for producing a net-nutritional confectionery topping, including the steps of mixing water and a non-sucrose sweetener and forming a wet portion, sifting one or more of a protein, a starch, a sweetener, a functional build back (FBB), and a flavoring, forming a dry portion, combining the wet portion and the dry portion with a melted fat, extruding the combination onto a surface, and drying the mixture at up to 225 F for up to 15 mins. The method can include wherein the melted fat is coconut oil. The method can include wherein the water is present in an excess to dissolve or emulsify the dry portion. The method can include wherein the non-sucrose sweetener is one of stevia or a sugar alternative. The method can include wherein the protein is a plant based protein forming a dominant component of the topping.

### CONCLUSION

Although the present disclosure has been illustrated and described herein with reference to example embodiments and specific examples thereof, it will be readily apparent to those of ordinary skill in the art that other embodiments and examples may achieve like results. All such equivalent embodiments and examples are within the spirit and scope of the present disclosure, are contemplated thereby, and are intended to be covered by the following claims. Specifically, it will be readily apparent to those of ordinary skill in the art that any of the aforementioned ingredients are contemplated in various different amounts, percentages, etc. to form the healthful confection. Further, the term “healthful” confection is meant to denote having some nutritional benefit beyond mere carbohydrates and sugars. That is, vitamin content, protein content, and the like due to the ingredients such that the healthful confection is considered to be healthy compared to conventional sprinkles. By healthy, we mean some net nutritional benefit to the consumer.

All ranges and parameters disclosed herein are understood to encompass any and all subranges subsumed therein, and every number between the endpoints. For example, a stated range of “1 to 10” should be considered to include any and all subranges between (and inclusive of) the minimum value of 1 and the maximum value of 10; that is, all subranges beginning with a minimum value of 1 or more, (e.g. 1 to 6.1), and ending with a maximum value of 10 or less, (e.g. 2.3 to 9.4, 3 to 8, 4 to 7), and finally to each number 1, 2, 3, 4, 5, 6, 7, 8, 9, and 10 contained within the range. All percentages and proportions herein are by weight unless otherwise specified.

What is claimed is:

1. A net-nutritional confectionery topping comprising:
a protein present in the amount up to about 100%; and any of
one or more starches present in the amount of 5% to 20%;
a fat present in the amount of 10% to 25%;
one or more functional build back (FBB) ingredients present in the amount of 5% to 30%;
one or more flavorings present in the amount of 0.1% to 5%.

2. The net-nutritional confectionery topping of claim 1, wherein the at least one starch is present in the amount of 9.8% to 11.4%, the protein is present in the amount of 1% to 50% %, the fat is present in the amount of 18.25% to 19.75%, the FBB is present in the amount of 24% to 26%, and the flavoring is present in the amount of 0.78% to 0.84%.

3. The net-nutritional confectionery topping of claim 1, further comprising at least one fruit and vegetable juice concentrate present in the amount of 9.5% to 10.5%.

4. The net-nutritional confectionery topping of claim 3, wherein the fruit and vegetable juice concentrate is one or more of: a carrot JC, a purple carrot JC, a red beet JC, a Jicama JC, and blue/green spirulina.

5. The net-nutritional confectionery topping of claim 1, wherein the protein is a vegetable based protein that defines the base ingredient of the topping.

6. The net-nutritional confectionery topping of claim 5, wherein the protein is one of a pea protein, a legume protein, a chickpea protein, a hemp protein, a soy protein, a seed protein, a rice protein, a nut protein, a lentil protein, or a faba bean protein.

7. The net-nutritional confectionery topping of claim 1, further comprising one or more of a vitamin, a mineral, a medication, a fiber source, or a stimulant in an amount up to 100%.

8. The net-nutritional confectionery topping of claim 1, wherein the FBB ingredient is one of Allulose, Erythritol, coconut sugar, and coconut powder.

9. The net-nutritional confectionery topping of claim 1, wherein the fat is one or more of cocoa butter and coconut oil.

10. The net-nutritional confectionery topping of claim 1, further comprising a stevia leaf sweetener or steviol glycosides.

11. The net-nutritional confectionery topping of claim 1, further comprising water present in the amount of 18% to 32%.

12. The net-nutritional confectionery topping of claim 1, wherein the topping does not include sucrose.

13. The net-nutritional confectionery topping of claim 1, wherein the flavoring is one of: vanilla, chocolate, and birthday cake flavor.

14. The net-nutritional confectionery topping of claim 1, wherein the topping is a chocolate sprinkle comprising a faba bean protein present in the amount of about 14.24%, a coconut sugar/Erythritol blend present in the amount of about 10.04%, a tapioca starch present in the amount of about 9.84%, a stevia leaf sweetener/steviol glycoside blend present in the amount of about 0.05%, a coconut oil present in the amount of about 19%, a chocolate flavoring present in the amount of about 0.79%, a cocoa powder present in the amount of about 14.25%, and water present in the amount of about 31.28%.

15. The net-nutritional confectionery topping of claim 1, wherein the topping is a rainbow sprinkle comprising: a faba bean protein present in the amount of about 15%, a coconut sugar present in the amount of about 26.12%, a stevia leaf sweetener/steviol glycoside blend present in the amount of about 0.05%, a coconut oil present in the amount of 18.55%, a vanilla flavor present in the amount of about 0.83%, a fruit juice concentrate present in the amount of about 10%, and water present in the amount of about 18.08%.

16. A method for producing a net-nutritional confectionery topping, comprising:
mixing water and a non-sucrose sweetener and forming a wet portion;
sifting one or more of a protein, a starch, a sweetener, a functional build back (FBB), and a flavoring, forming a dry portion;
combining the wet portion and the dry portion with a melted fat;
extruding the combination onto a surface; and
drying the mixture at up to 225 F for up to 15 mins.

17. The method of claim 16, wherein the melted fat is coconut oil.

18. The method of claim 16, wherein the water is present in an excess to dissolve or emulsify the dry portion.

19. The method of claim 16, wherein the non-sucrose sweetener is one of stevia or a sugar alternative.

20. The method of claim 16, wherein the protein is a plant based protein forming a case component of the topping.
